(19) United States
(12) Patent Application Publication
(10) Pub. No.: US 2012/0314830 A1
(43) Pub. Date: Dec. 13, 2012

(54) INSTALLATION FOR PRODUCING POWER FROM A GAS-COOLED FAST NUCLEAR REACTOR

(75) Inventors: Nicolas Tauveron, Grenoble (FR); Fabrice Bentivoglio, Cras (FR)

(73) Assignee: COMMISSARIAT A L'ENERGIE ATOMIQUE ET AUX ENERGIES ALTERNATIVES, Paris (FR)

(21) Appl. No.: 13/581,162

(22) PCT Filed: Feb. 23, 2011
(86) PCT No.: PCT/FR2011/000108

§ 371 Date: Aug. 24, 2012

(30) Foreign Application Priority Data
Feb. 24, 2010 (FR) 10 00749

(51) Int. Cl. G21C 15/253

(52) U.S. Cl. 376/386

(57) ABSTRACT

A power production installation including a primary circuit containing gas passing via a nuclear reactor, via a first heat exchanger, and via a blower. A secondary circuit containing incondensable gas passes via the first heat exchanger, and via a turbine and a compressor fitted on the same shaft. The blower is driven by the shaft. The gases in the primary and secondary circuits are of the same nature, and the pressure in the secondary circuit is automatically regulated by the pressure in the primary circuit.

### BACKGROUND OF THE INVENTION

The invention relates to fourth-generation nuclear reactors, in particular those referred to as GFR, standing for Gas-cooled Fast Reactor. The invention relates more particularly to cooling of such a reactor in an accident situation.

What is meant by “fast” reactor is a reactor using a coolant that does not slow down the neutrons emitted by the nuclear reaction and does not comprise a moderator.

### STATE OF THE ART

FIG. 1 represents an power production installation from a combined indirect cycle GFR of the type studied in the article presented at the conference Proceedings of ICAPP '09, Tokyo, Japan, 10-14 May 2009, P 9378, “CATHARE SIMULATION OF TRANSIENTS FOR THE 2400 MW GAS FAST REACTOR CONCEPT”. A primary circuit 10, having pure helium as coolant, passes via the core of a nuclear reactor 12 and via a heat exchanger 14. The helium is kept in circulation by an electrically supplied blower 16 placed in the circuit between the output of heat exchanger 14 and the input of reactor 12. The helium is at a pressure of about 70 bar.

This type of indirect cycle reactor differs from a direct cycle reactor by the fact that the primary circuit does not comprise a turbine. The primary circuit simply serves the purpose of transferring heat from the core of reactor 12 to heat exchanger 14, which facilitates confinement of the reactor and of the primary circuit components, thereby limiting risks of activation, of missiles originating from losses of turbine blades and water inlet.

A secondary circuit 17, having a mixture of helium and nitrogen as coolant base, passes successively through heat exchanger 14, a gas turbine 18, a second heat exchanger 20, and a compressor 22. Turbine 18 and compressor 22 are fitted on one and the same shaft 24 which also drives an alternator 26.

The mixture of helium and nitrogen comprises from 50 to 70% volume fraction of helium, the remainder being nitrogen. The pressure of the mixture is about 65 bar on inlet of turbine 18 and about 40 bar on outlet of turbine 18.

A tertiary circuit 28, the base of which is water in vapor phase and in liquid phase, passes successively via heat exchanger 20, a steam turbine 30 and a pump 32. The steam turbine drives an alternator 36 thus completing the electricity production of alternator 26. This twofold electricity production source justifies the name of combined indirect cycle.

The distribution of the powers generated at the level of alternators 26 and 36 is respectively about ⅓ and ⅔.

The installation is provided with an emergency cooling system 38. A helium-based emergency primary circuit 40 passes via reactor 12, a heat exchanger 42, and a blower 44. In normal operation, this emergency primary circuit is cut-off by a valve 46, and blower 44 is shut down. A water-based emergency secondary circuit 48 passes via heat exchanger 42 and in a tank filled with water 50. In general, several redundant emergency systems are provided.

Reactor 12 and primary circuits 10 and 40 are placed in an inner containment 52 itself placed in an outer containment not shown here. The inner containment is designed to ensure a sufficient fall-back pressure of the reactor after a breach, of about 5 to 10 bars, and the outer containment is designed to contain any leakage of elements able to be activated by the reactor to the outside.

In the case of an accident affecting the reactor primary circuit, for example a breach opening in the piping at the inlet of the reactor, the pressures of the inner containment and of the primary circuit are equalled out. The pressure increase in the inner containment is detected and causes reactor shutdown by insertion of control rods into its core. All the electric circuitry of the main circuits is shut down as it uses high power and is therefore supplied by the electric power system, whereas emergency cooling system 38 is for its part low-power and therefore assumed to be able to be backed up by stand-alone power supplies (electricity generating sets or batteries). The control rods immediately stop the nuclear reaction, but residual heat continues to be produced in the reactor and has to be removed. Emergency cooling system valve 46 is open, and blower 44 is switched on. The residual heat of the reactor is thus removed to water tank 50 by helium circuit 38, heat exchanger 42, and water circuit 48.

This type of installation therefore requires a certain number of operations to be implemented in case of an accident. These operations can naturally be automated, but they present a risk of malfunctioning that is all the greater the larger the number of operations and of elements involved.

The risk of malfunctioning is increased by the fact that an emergency cooling device that remains unused in normal circumstances has to be relied on. To limit this risk, regular checking and maintenance operations of the cooling device have to be performed, thereby increasing the operating cost.

### SUMMARY OF THE INVENTION

It is observed that an emergency cooling system has to be provided for a gas-cooled reactor that requires little maintenance without penalizing its reliability.

To satisfy this requirement, a power production installation is provided comprising a primary circuit containing gas passing via a nuclear reactor, via a first heat exchanger, and via a blower. A secondary circuit containing an incondensable gas passes via the first heat exchanger, and via a turbine and a compressor fitted on the same shaft. The blower is driven by the shaft. The gases in the primary and secondary circuits are of the same nature, and the pressure in the secondary circuit is automatically regulated by the pressure in the primary circuit.

### BRIEF DESCRIPTION OF THE DRAWINGS

Other advantages and features will become more clearly apparent from the following description of particular embodiments given for non-restrictive example purposes only and illustrated by means of the appended drawings, in which:

FIG. 1, described in the foregoing, represents a conventional installation with a combined indirect cycle GFR nuclear reactor;

FIG. 2 schematically represents a GFR installation having an autonomous emergency cooling capacity; and

FIGS. 3A to 3D represent various plots of the variations of parameters in the case of an accident affecting the installation of FIG. 2.

### DESCRIPTION OF A PREFERRED EMBODIMENT OF THE INVENTION

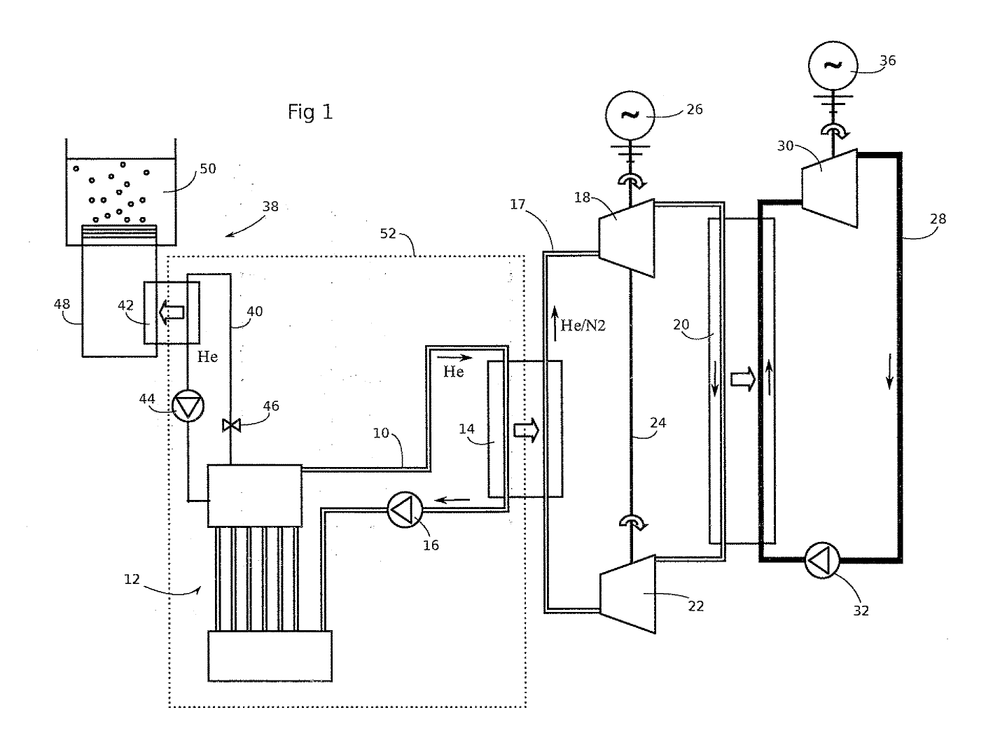

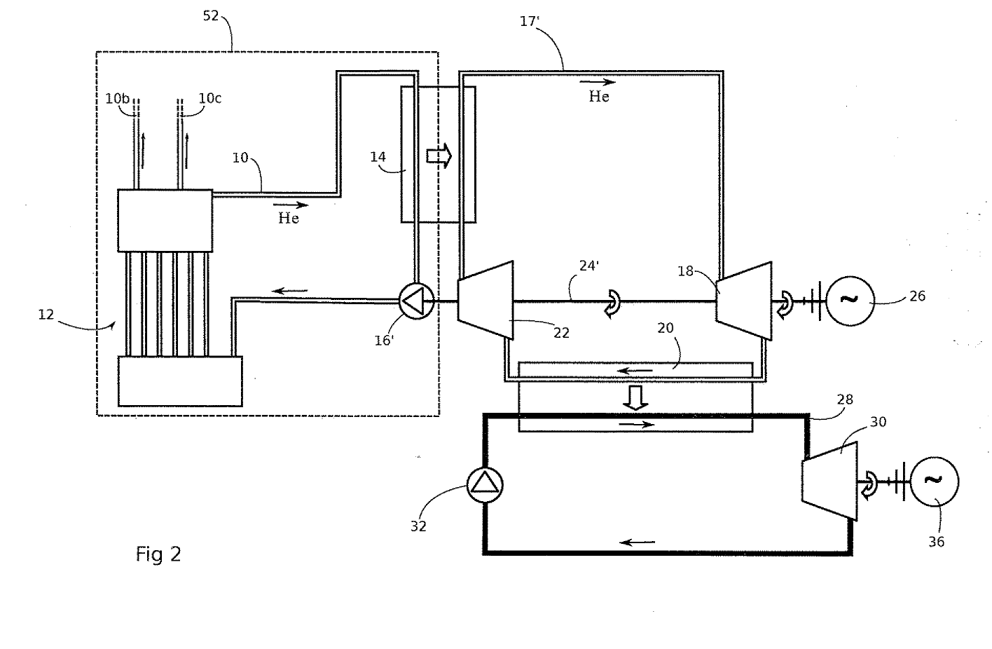

In FIG. 2 representing an installation having an autonomous and passive emergency cooling capacity, the same elements are to be found as in FIG. 1, designated by the same reference numerals. What is meant by “autonomous cooling capacity” is that the installation is able to remove residual heat from the shut-down reactor, for example following an accident, without a specific intervention of an operator or of a controller outside shutdown of the reactor and disconnection of the alternators. To do this, components serving the purpose of producing power in normal operation of the installation are used to cool the reactor.

A difference with respect to the installation of FIG. 1 is that the blower of primary circuit 10, here bearing the reference numeral 16′, is driven by the same shaft 24′ as that connecting turbine 18 and compressor 22 of secondary circuit 17′. Blower 16′ is therefore always coupled to turbine 18 of the secondary circuit, in particular when the reactor is shut down in case of an accident.

Apart from simplification of the installation due to the fact that there is no longer a need for a separate motor to operate blower 16′, it will be seen in the following that this configuration does away with the need for emergency cooling system 38 of the conventional installation of FIG. 1. As components used in normal operation are used for emergency cooling, it is possible to be sure that these components are operational at all times. This avoids having to perform checking and maintenance operations of systems scheduled to operate under exceptional circumstances only.

Preferably, unlike the installation of FIG. 1, the gas in the secondary circuit is the same (pure helium) as in the primary circuit, and it is at the same pressure (for example 70 bar). With this choice, the tightness constraints of the seal are relaxed and its design can be simpler.

Furthermore, for the seal to be subjected to a pressure differential that is practically zero under all circumstances, including in an accident situation, the secondary circuit pressure is automatically regulated by the primary circuit pressure. This servo-control is performed for example by a simple valve connecting the primary and secondary circuits. Under nominal conditions, the valve is closed. In an accident condition of the type where primary circuit 52 is depressurised, the pressure difference on each side of this valve is greater than the mechanical calibration pressure of the valve, resulting in opening of the latter. In an alternative version, a more complex set of valves would servo the pressure of circuit 17′ to that of circuit 10 by discharging the excess volume from pipe IT of the secondary circuit to confinement 52.

In order moreover to be able to cope with any unscheduled risk, it is preferable for the emergency cooling system be redundant. Thus, within the scope of FIG. 2, several couples of primary and secondary circuits, for example three, are preferably scheduled around any one reactor 12. Two outlets of redundant primary circuits 10b and 10c have been symbolized. Primary circuits 10, 10b and 10c communicate with one another in the reactor. For reasons of feasibility, these three primary circuits are not isolated from one another in the reactor, which results in a breach in one of the systems necessarily affecting the other two systems.

Each redundant secondary circuit is provided with its own turbine 18, compressor 22 and alternator 26, coupled to a shaft 24′ driving blower 16′ of the associated redundant primary circuit. Tertiary circuit 28 does not for its part need to be redundant. It can pass through a heat exchanger 20 shared by all the redundant secondary circuits, or pass through several heat exchangers 20 each of which is associated with a respective redundant secondary circuit.

It is considered that one of the most severe accidents that can occur is opening of a 25 cm breach in the “cold” leg of primary circuit 10, i.e. in the return section from heat exchanger 14 to reactor 12. A breach in the “hot” leg of the system is not envisaged, as the piping corresponding to the hot leg is generally placed inside the piping of the cold leg for thermal optimization reasons. The diameter of the breach corresponds to the maximum diameter of the pipes connected to the main pipe of the primary circuit.

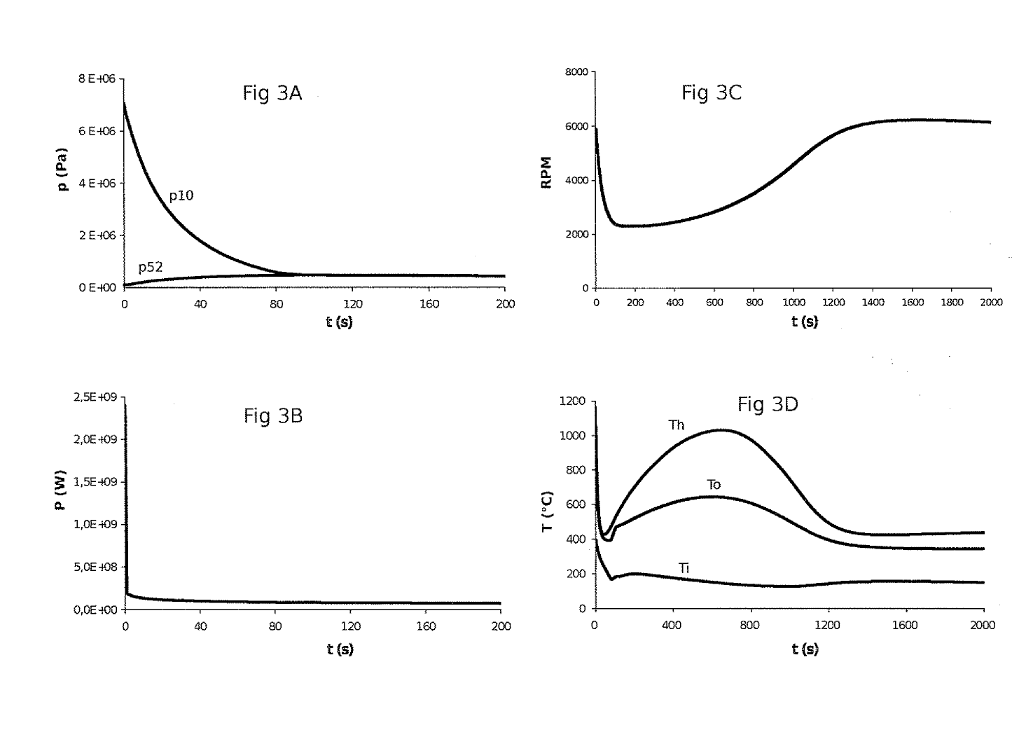

FIGS. 3A to 3D represent variations in time t of several parameters following an accident of the above-mentioned type in an example of an installation comprising three couples of redundant primary and secondary circuits. These results were obtained by simulations made with the CATHARE2 V25_{—}2 thermal-hydraulic accident system software.

FIG. 3A represents the variations of pressure p10 of the primary circuits and of pressure p52 in the inner confinement following opening of the breach in one of the primary circuits. FIG. 3B represents the variations of the reactor power. FIG. 3C represents the variations of the speed of rotation of shafts 24′. FIG. 3D represents the variations of the maximum temperature of the fuel cladding Th in the reactor core, of the helium temperature on reactor outlet To, and of the helium temperature on reactor Ti inlet.

The installation operates with the following parameters for example purposes:
Primary and secondary circuits: pure helium at 70 bar;
Reactor power: 2400 MW;
Nominal rotation speed of each shaft 24′: 5900 rpm;
Power generated on shafts 24′ (total): 134 MW;
Temperatures (° C.) :
   Reactor outlet: 780°;
   Reactor inlet: 400°;
   Turbine 18 inlet: 750°;
   Compressor 22 inlet: 232°;
Primary flowrate (total): 1216 kg/s;
Secondary flowrate (total): 1122 kg/s.

With these parameters, an efficiency of 45.6% is obtained by simulation with CEA CYCLOP software.

Starting from t=0, in FIG. 3A, the leak in primary circuit 10 causes a rapid decrease of pressure p10. The leak is confined in confinement 52, pressure p52 of which starts to increase to equalize with pressure p10 after 80 s. The pressure of the secondary circuits being servoed to the pressure of the primary circuits, the pressure of the secondary circuits follows the variations of pressure p10.

This pressure decrease is immediately detected by a controller which stops the reactor by inserting control rods into the reactor core. The reactor power drops within a few seconds to a residual power of a few percent of the nominal power, as illustrated in FIG. 3B. This residual power does however have to be removed.

The mass flowrate of gas of the primary circuit drops proportionally to the pressure decrease. The heating power of the gas decreases correlatively. This combined with the power decrease of the reactor results in a decrease of the power transmitted to the secondary circuit, tending to decrease the speed of rotation of turbine 18, as illustrated in FIG. 3C.

Nevertheless, as the heating power of the gas drops more slowly than the reactor power, the heat exchange remains favourable so that the temperatures of the reactor start to decrease, as illustrated in FIG. 3D.

After 80 s, when the pressure of the gas in the primary circuit reaches its lowest value, the speed of rotation of turbine 18 is also at its lowest level. The heat removal conditions from the reactor are unfavourable, and the reactor temperatures start to increase.

However, as the speed of rotation of turbine 18 decreases with respect to its nominal value, alternator 26 starts to operate as a motor consuming power on the power grid, which is detected by a controller as being a prohibited event. The controller disconnects the alternator from the power grid. As from this moment, the turbine has no more power to transmit to the alternator, and all the power it still produces is transmitted to compressor 22 and to blower 16′. The little power that the damaged primary circuit transfers to the secondary circuit from the reactor is sufficient to speed up rotation of the turbine, and therefore of blower 16′, and to reactivate the heat transfer by the primary circuit of the reactor to the secondary circuit.

As the speed of rotation of the turbine progressively increases, the temperatures of the reactor (FIG. 3D) pass via a maximum and start to decrease again to reach a stable low value at the moment the speed of rotation of the turbine reaches a stable value close to the nominal value. From this point on, the installation operates normally at partial operating conditions maintained by the residual heat of the reactor.

It is observed that the maximum temperature reached in the reactor core during this accident phase is lower than the nominal temperature of the core in normal operation. Dangerous conditions are therefore not approached at any time during the accident phase.

The operations to be performed to manage the accident are moreover limited. The only operation remaining to be performed is that consisting in shutting the reactor down by inserting the control rods. The operation consisting in disconnecting the alternators from the power grid is an operation that is anyway scheduled in normal operation to adapt the installation to power demand fluctuations on the power grid.

The document Proceedings of Gas-Cooled Reactor Information Meeting, Oak Ridge National Laboratory, 27-30 Apr. 1970, “GAS TURBINE POWER CONVERSION SYSTEMS FOR HELIUM COOLED BREEDER REACTORS” describes a reactor installation comprising a primary circuit with helium and a secondary circuit with carbon dioxide in liquid and vapour phases. In this installation, a dedicated turbine of the secondary circuit drives a blower of the primary circuit. An alternator and a compressor are driven by a second turbine independent from the turbine dedicated to the blower.

It should be noted that this type of installation does not have an autonomous emergency cooling capacity. When a reactor power decrease occurs following an accident, the heat transmitted to the secondary circuit does in fact become insufficient to maintain the carbon dioxide in vapour phase. The turbines are drowned, in particular the one dedicated to the blower, and the blower stops, so that the primary circuit can no longer remove the residual heat from the reactor.

The gas used in the secondary circuit of the installation of FIG. 2 is consequently preferably an incondensable gas, helium being an example.

Reverting back to FIG. 2, it can be observed that shaft 24′ passes from secondary circuit 17′ to primary circuit 10 to drive blower 16′. This shaft should normally be provided with a rotating seal which isolates the primary and secondary circuits from one another. Blower 16′, within the scope of the above-mentioned example, consumes a power of about 17 MW. Shaft 24′ has a consequent diameter, its rotation is relatively fast (about 6000 rpm), and it has to withstand a high temperature (400°).

With the pressures used in the primary and secondary circuits of a conventional installation (FIG. 1), the seal will further have to withstand a pressure difference of 5 bar. Design of such a seal is difficult.

On account of the fact that pure helium is used in the secondary circuit instead of the helium/nitrogen mixture of FIG. 1, and that the pressure of the secondary circuit is equal to the pressure of the primary circuit, a different power distribution than that of FIG. 1 will be used between the secondary and tertiary circuits in order to optimize the efficiency and size of the machine. Less than 20%, preferably about 15%, of the power is thus produced in the secondary circuit, and the rest is produced in the tertiary circuit.

Numerous variants and modifications of the embodiments described here will be apparent to the person skilled in the trade. Although helium has been described as coolant gas, any other gas meeting the desired requirements can also be used, in particular a gas that is not condensable in the secondary circuit.

1-6. (canceled)

7. A power production installation comprising:
a primary circuit containing a first gas passing via a nuclear reactor, a first heat exchanger, and a blower driven by a shaft;
a secondary circuit containing an incondensable gas passing via the first heat exchanger, a turbine and a compressor,
wherein the blower, the turbine and the compressor are driven by the shaft.

8. The installation according to claim 7, wherein the primary and secondary circuits are configured so that the first gas and the incondensable gas are at a same pressure.

9. The installation according to claim 8, wherein a valve connects the primary circuit to the secondary circuit and is configured so that the pressure in the secondary circuit is automatically regulated by the pressure in the primary circuit.

10. The installation according to claim 8, comprising:
a second heat exchanger placed in the secondary circuit wherein the incondensable gas is pure helium;
a tertiary circuit containing a condensable fluid, passing via the second heat exchanger, and a turbine and a pump;
whereby a power produced on a shaft of the turbine of the tertiary circuit is more than 80% of a total power produced.

11. The installation according to claim 8, wherein the first gas of the primary circuit and the incondensable gas of the secondary circuit are helium at a pressure of about 70 bar.

12. The installation according to claim 7, comprising several redundant couples of primary and secondary circuits, the primary circuits of which pass in the same nuclear reactor.
